(19) United States
(12) Patent Application Publication
(10) Pub. No.: US 2022/0020092 A1
(43) Pub. Date: Jan. 20, 2022

(54) FUND TRACKING SYSTEM, FUND TRACKING METHOD AND GRAPHIC USER INTERFACE

(71) Applicant: INDUSTRIAL TECHNOLOGY RESEARCH INSTITUTE, HSINCHU (TW)

(72) Inventors: En-Tzu WANG, Kaohsiung City (TW); Tsung-Wen TSO, Hsinchu City (TW); Chuan-Hsiang HAN, Taoyuan City (TW)

(73) Assignee: INDUSTRIAL TECHNOLOGY RESEARCH INSTITUTE, HSINCHU (TW)

(21) Appl. No.: 17/104,843

(22) Filed: Nov. 25, 2020

Related U.S. Application Data
(60) Provisional application No. 63/051,951, filed on Jul. 15, 2020.

(30) Foreign Application Priority Data
Oct. 21, 2020 (TW) 109136450

(51) Int. Cl. G06Q 40/06; G06F 3/0484; G06Q 10/04; G06Q 30/00; G06N 3/08; G06N 3/04

(52) U.S. Cl. CPC G06Q 40/06; G06F 3/0484; G06Q 10/047; G06N 3/04; G06Q 10/04; G06N 3/08; G06Q 30/018

(57) ABSTRACT

A fund tracking system, a fund tracking method and a graphic user interface are provided. The fund tracking method is used to track a target fund. The fund tracking method includes the following steps. Several ETF asset classes are obtained according to a fund benchmark index of the target fund. Several representative ETFs are obtained according to the ETF asset classes. A simulated investment portfolio is generated according to the representative ETFs. Whether the simulated investment portfolio meets a verification condition is verified. If the simulated investment portfolio meets the verification condition, the simulated investment portfolio is outputted.

This application claims the benefit of U.S. provisional application Ser. No. 63/051,951, filed Jul. 15, 2020, the subject matter of which is incorporated herein by reference. This application claims the benefit of Taiwan application Serial No. 109136450, filed Oct. 21, 2020, the disclosure of which is incorporated by reference herein in its entirety.

### TECHNICAL FIELD

The disclosure relates in general to a fund tracking system, a fund tracking method and a graphic user interface.

### BACKGROUND

The return of a mutual fund depends on the Return of Investment (ROI) change of the risky assets held by the fund. It would be helpful to the forecast of the future trend of the fund if the future trend of the risky assets held by the fund can be forecasted. For example, when the OPEC announces a production cut, the petroleum related index tends to rise. Therefore, it can be forecasted that those mutual funds holding a large amount of petroleum assets will experience a period of increase.

However, since the risky assets held by a fund normally cover several industries and markets and the holding proportion of each asset is different, it is difficult to forecast the future trend of the fund according to the trend of one single asset.

Particularly, the fund discloses to the public only limited information. For example, the fund normally discloses only the names of the assets with larger weights and their weights as well as summarized information such as the weights by countries and the weights by industries. Besides, the disclosure cycle of the fund is long. For example, the disclosure cycle for the held assets is such as one month, one season or semi-year.

Due to the limited information, the investors cannot effectively assemble the disclosed information of the assets with the market information to generate investment decisions timely.

### SUMMARY

The disclosure is directed to a fund tracking system, a fund tracking system and a graphic user interface.

According to one embodiment, a fund tracking method used to track a target fund is provided. The fund tracking method includes the following steps. Several Exchange Traded Fund (ETF) asset classes are obtained according to a fund benchmark index of the target fund. Several representative ETFs are obtained according to the ETF asset classes. A simulated investment portfolio is generated according to the representative ETFs. Whether the simulated investment portfolio meets a verification condition is verified. If the simulated investment portfolio meets the verification condition, the simulated investment portfolio is outputted.

According to another embodiment, a fund tracking system is provided. The fund tracking system is used to track a target fund. The fund tracking system includes a selection unit and a generation unit. The selection unit includes an asset class selector and an Exchange Traded Fund (ETF) selector. The asset class selector is used to obtain several ETF asset classes according to a fund benchmark index of the target fund. The ETF selector is used to obtain several representative ETFs according to the ETF asset classes. The generation unit includes an assembler and a verifier. The assembler is used to generate a simulated investment portfolio according to the representative ETFs. The verifier is used to verify whether the simulated investment portfolio meets a verification condition. If the simulated investment portfolio meets the verification condition, the simulated investment portfolio is outputted.

According to an alternative embodiment, a graphic user interface is provided. The graphic user interface is used for a user to track a target fund. The graphic user interface includes a setting button and a fund forecasting result button. The setting button is used to input the target fund. Several exchange traded fund (ETF) asset classes are obtained according to a fund benchmark index of the target fund. Several representative ETFs are obtained according to the ETF asset classes. A simulated investment portfolio is generated according to the representative ETFs. The fund forecasting result button is used to display an uptrend value or an overall trend of the simulated investment portfolio.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a fund tracking system according to an embodiment.

FIG. 2 is a flowchart of a fund tracking method according to an embodiment.

FIG. 3 is an example of the step S110 performed by an asset class selector.

FIG. 4 is an example of the step S130 performed by an assembler and the step S140 performed by a verifier.

FIG. 5 is an example of a verification procedure P45.

FIG. 6 is an example of the step S160 performed by a trend forecasting unit.

FIG. 7 is an example of a market opinion processing procedure P61.

FIG. 8 is an example of a feature extraction procedure P62.

FIG. 9 is an example of a forecasting procedure P63.

FIG. 10 is a schematic diagram of a graphic user interface according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

An Exchange Traded Fund (ETF) is formed of several risky assets. In comparison to individual assets, the ETF meets the composition features of a fund. Also, in comparison to the fund, the ETF has a transparent asset allocation, and a high frequency of update in transactions (such as daily). Moreover, the ETF with low tracking errors can directly represent its tracking index. Therefore, in the present embodiment, the researchers use the ETF to track a fund and further forecast the future trend of the fund.

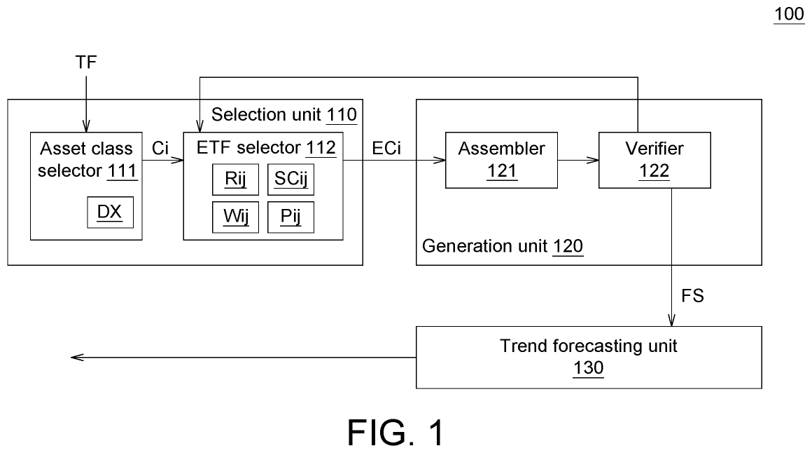

Referring to FIG. 1, a block diagram of a fund tracking system 100 according to an embodiment is shown. The fund tracking system 100 can be realized by a server host, a computer, a cloud computing center or a smart phone. The fund tracking system 100 includes a selection unit 110, a generation unit 120 and a trend forecasting unit 130. The selection unit 110, the generation unit 120 and the trend forecasting unit 130 can be realized by a circuit, a chip, a circuit board, or a storage device storing programming codes. The selection unit 110 includes an asset class selector 111 and an ETF selector 112. The generation unit 120 includes an assembler 121 and a verifier 122. The asset class selector 111, the ETF selector 112, the assembler 121 and the verifier 122 can be realized by a circuit, a chip, a circuit board, or a storage device storing programming codes. The fund tracking system 100 of the present embodiment selects several representative ETFs ECi (i=1, 2, . . . ) using the selection unit 110. The generation unit 120 generates a simulated investment portfolio FS according to the representative ETFs ECi (i=1, 2, . . . ). Once the simulated investment portfolio FS is obtained, the target fund TF will be accurately tracked. Furthermore, the trend of the target fund TF can be forecasted according to the simulated investment portfolio FS. The operation of the above elements is disclosed below with an accompanying flowchart.

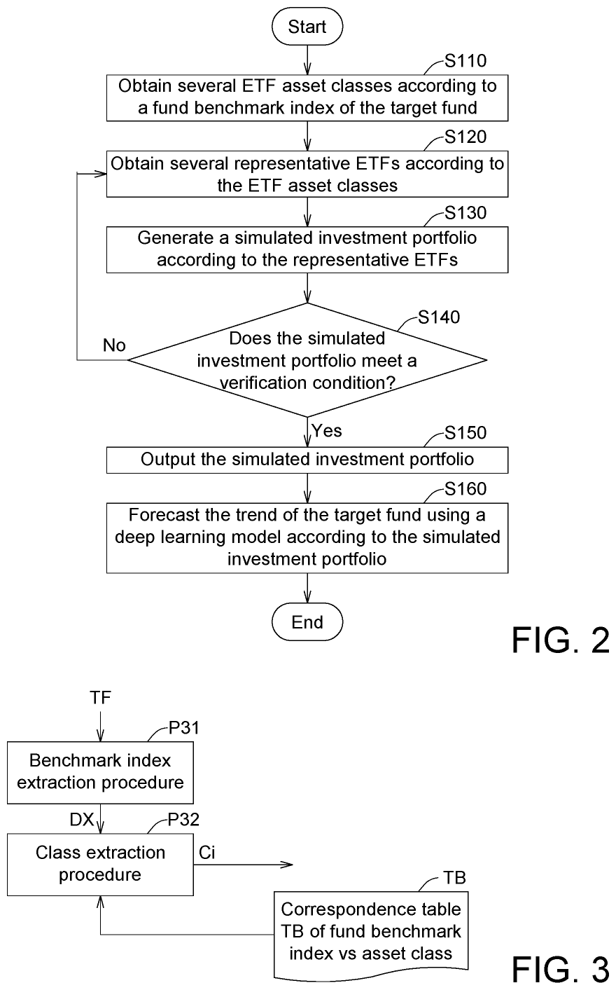

Refer to FIG. 1 and FIG. 2. FIG. 2 is a flowchart of a fund tracking method according to an embodiment. In step S110, several ETF asset classes Ci (i=1, 2, . . . ) are obtained by the asset class selector 111 according to a fund benchmark index DX of the target fund TF. Examples of the ETF asset classes Ci include industry, region, fixed income, and exchange rate. Table 1 lists the relation between ETF asset classes Ci and fund benchmark index DX.

Referring to FIG. 3, an example of the step S110 performed by the asset class selector 111 is shown. After the target fund TF is obtained by the asset class selector 111, the fund benchmark index DX is extracted from the fund prospectus or fund website using a benchmark index extraction procedure P31. For example, the fund benchmark index DX of the equity fund “Fidelity Funds—Global Income Fund” is “MSCI ACWI NR USD”; the fund benchmark index DX of the bond fund “Fidelity Funds—USD Bond Fund” is “ICE BofA US LC Corp&Govt TR USD”. The fund benchmark index DX corresponds to the investment target and region of the target fund TF. If two different target funds TF have the same fund benchmark index DX, the two target funds TF have the same investment target and region.

Then, in the class extraction procedure P32, the ETF asset classes Ci (i=1, 2, . . . ) are obtained using a look-up table (such as the correspondence table TB of fund benchmark index vs asset class). The fund benchmark index DX only has a limited quantity, and therefore can be provided and maintained manually. Referring to Table 1, the correspondence table TB of fund benchmark index vs asset class are listed. The ETF asset classes Ci (i=1, 2, . . . ) corresponding to different fund benchmark index DX may have different quantities. Since the fund benchmark index DX has only a limited range of change, the correspondence table TB of fund benchmark index vs asset class can be easily maintained.

TABLE 1

| Fund | | |
|---|---|---|
| Benchmark | ETF Asset Class Ci | |
| Index DX | (i = 1, 2, . . .) | Quantity |
| MSCI ACWI NR | Basic Materials, Industrial, . . . , Utilities | 11 |
| USD | | |
| ICE BofA US | Bond, Build America Bonds, Fixed | 12 |
| LC Corp&Govt | Income, . . . , U.S. Broad Market Bonds | |
| TR USD | | |
| . . . | . . . | . . . |

Then, in the step S120 of FIG. 2, several representative ETFs ECi (i=1, 2, . . . ) are obtained by the ETF selector 112 according to the ETF asset classes Ci (i=1, 2, . . . ). In the present step, the obtained representative ETF EC1 is the best among several ETFs in the ETF asset class C1; the obtained representative ETF EC2 is the best among several ETFs in the ETF asset class C2; and the rest can be obtained by the same analogy. The best ETF is selected from each of the representative ETFs ECi (i=1, 2, . . . ) according to a ranking Rij. The score is such as “letter grade/Fit value”. The letter grade is the score of efficiency and tradability. The letter grade can objectively measure the operation and tradability of the ETFs. The Fit value substantially measures the potential of the ETF occupying a larger market share and can be regarded as the selection of investor demand. If an investor wants to go with the market trend, he/she will select the ETF with larger Fit value. Conversely, if an investor does not want to follow the market trend, he/she will select the ETF with lower Fit value. In the present embodiment, the selection of ETF with larger Fit value is exemplified.

For example, three ETF scores are such as “A/85”, “B/72”, “B/85”. When the three ETF scores are compared, the scores are firstly sorted by letter grade (A>B, B>C, and the rest can be obtained by the same analogy), and then are sorted by the Fit value (in a descending order). Therefore, the three ETF scores are sorted as: “A/85”, “B/85”, “B/72”, and the values of the ranking Rij respectively are 1, 2, 3.

Referring to Table 2, 11 representative ETFs ECi (i=1, 2, . . . ) with respect to 11 ETF asset classes Ci (i=1, 2, . . . ) obtained according to the ranking Rij are listed.

TABLE 2

| ETF asset class Ci | Representative ETF ECi | | |
|---|---|---|---|
| (i = 1, 2, . . .) | (i = 1, 2, . . .) | Score | Ranking Rij |
| Basic Materials | S&P Metals and Mining Select | A/76 | 1 |
| | Industry | | |
| Industrial | S&P Industrial Select Sector | A/91 | 1 |
| | Index | | |
| Real Estate | Dow Jones US Select REIT | A/86 | 1 |
| | Total Return Index | | |
| Finance | S&P Banks Select Industry | A/69 | 1 |
| Energy | S&P Energy Select Sector | A/94 | 1 |
| | Daily Capped 25/20 Index | | |
| . . . | . . . | . . . | |

In an embodiment, the selection of representative ETFs can be based on the best ranking Rij as well as the selection count SCij. For example, a selected representative ETF may be determined as unsuitable and removed in the subsequent procedure of generating a simulated investment portfolio FS. Therefore, in step S120 of selecting representative ETFs, it is better not to select those representative ETFs which are removed often.

The ETF selector 112 can select the representative ETFs ECi (i=1, 2, . . . ) according to formulas (1) and (2):

$$\begin{matrix}{W}_{i j} = \frac{1}{( s {c}_{ij} + 1 ) {R}_{ij}^{2}} & ( 1 ) \\ {P}_{i j} = \frac{{W}_{ij}}{{W}_{i 1} + {W}_{i 2} + ⋯ + {W}_{im}} & ( 2 )\end{matrix}$$

In the present specification, i refers to the i-th ETF asset class, and j refers to j-th ETF in the same asset class; Rij refers to the ranking of the j-th ETF in the i-th ETF asset class; SCij refers to the selection count of the j-th ETF in the i-th ETF asset class; Wij refers to the selection probability weight of the j-th ETF in the i-th ETF asset class; Pij refers to the selection probability of the j-th ETF in the i-th ETF asset class.

As indicated in formula (1), the smaller the ranking Rij, the larger the selection probability weight Wij; the smaller the selection count SCij, the larger the selection probability weight Wij. Therefore, the ETF with higher ranking Rij and lower selection count SCij is more likely to be selected.

Then, in the step S130 of FIG. 2, a simulated investment portfolio FS is generated by the assembler 121 according to the representative ETFs ECi (i=1, 2, . . . ). Then, in the step S140 of FIG. 2, whether the simulated investment portfolio FS meets a verification condition is verified by the verifier 122.

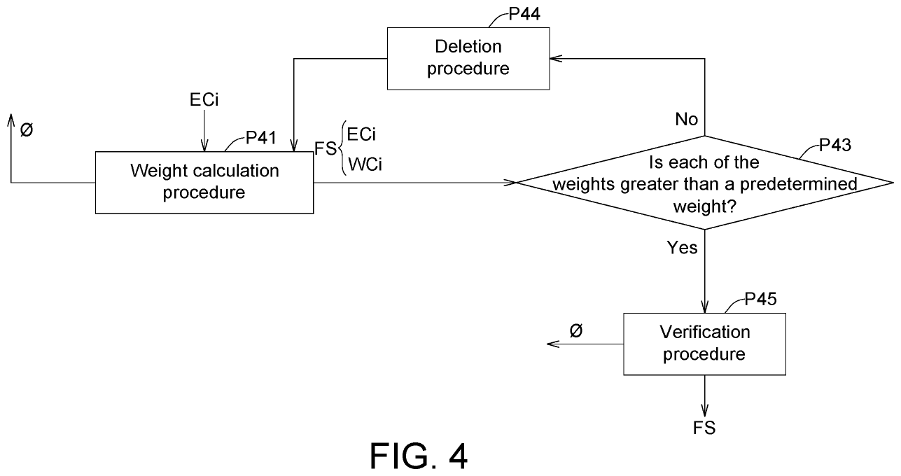

The simulated investment portfolio FS is a product of the representative ETFs ECi (i=1, 2, . . . ) and the weights WCi (i=1, 2, . . . ) (that is, Σᵢ WCᵢ*ECᵢ). Referring to FIG. 4, an example of the step S130 performed by the assembler 121 and the step S140 performed by the verifier 122 is shown.

After the representative ETFs ECi (i=1, 2, . . . ) are obtained by the assembler 121, the weights WCi (i=1, 2, . . . ) can be calculated in the weight calculation procedure P41 according to a regression model, such as a Lasso regression model or a ridge regression model. During the process of calculating the weights WCi (i=1, 2, . . . ) by the assembler 121, the following condition must be met: the sum of all weights WCi (i=1, 2, . . . ) is 1 (that is, Σᵢ WCᵢ=1). Moreover, each of the weights WCi (i=1, 2, . . . ) is greater than or equivalent to 0 (that is, WCᵢ1≥0), which implies that there are no missing weights. However, if the assembler 121 cannot calculate the weights WCi (i=1, 2, . . . ) under the above condition, the assembler 121 will output a null value 0.

Then, in the weight confirmation procedure P43, whether each of the weights WCi (i=1, 2, . . . ) is greater than a predetermined weight is determined by the assembler 121. When a particular weight is not greater than the predetermined weight, this implies that the representative ETF corresponding to the particular weight is not sufficiently representative and needs to be deleted in the deletion procedure P44, and the weight calculation procedure P41 will be performed again.

After the weight calculation procedure P41 and the weight confirmation procedure P43 are smoothly performed, the method proceeds to the verification procedure P45.

In the verification procedure P45, whether the simulated investment portfolio FS meets the verification condition is verified by the verifier 122. The verification condition is as follows: a similarity in the change of Return of Investment (ROI) between the simulated investment portfolio FS and the target fund TF is less than a threshold value. The verifier 122 analyzes the similarity using the Kolmogorov-Smirnov test (K-S test).

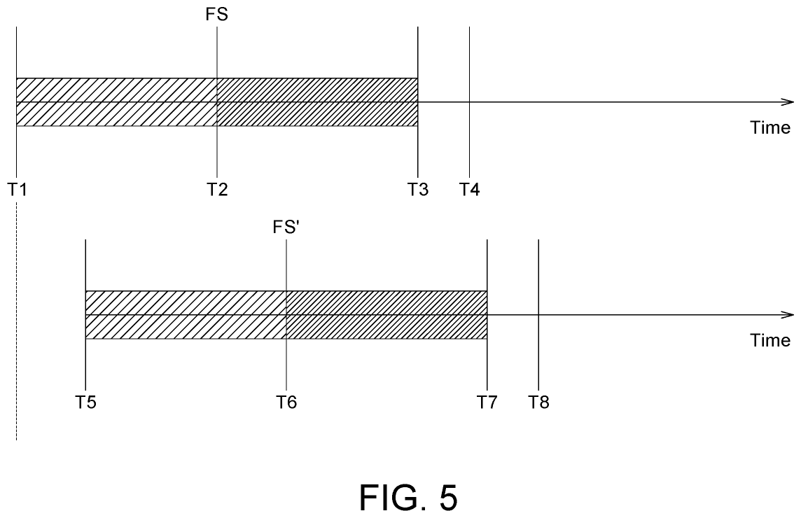

Referring to FIG. 5, an example of a verification procedure P45 is shown. As indicated in the upper part of FIG. 5, the assembler 121 generates a simulated investment portfolio FS at time point T2 according to the information of time points T1 to T2. Then, the verifier 122 collects the ROI change of the simulated investment portfolio FS and the ROI change of the target fund TF during time points T2 to T3, and determines whether the similarity between the ROI change of the simulated investment portfolio FS and the ROI change of the target fund TF is less than a threshold value. If the simulated investment portfolio FS passes verification, the simulated investment portfolio FS can be used to perform forecasting after time point T4.

As indicated in the lower part of FIG. 5, to perform forecasting after time point T8, a new simulated investment portfolio FS' can be generated during time points T5 to T6. If the simulated investment portfolio FS' newly generated at time point T6 can pass verification during time points T6 to T7, then the simulated investment portfolio FS' can be used to perform forecasting after time point T8.

Generally speaking, the investment proportion of the target fund TF in the same industry will not change dramatically over a short period of time. Between two disclosure cycles (as short as one month), the change in the investment proportion of the target fund TF in the same industry normally is less than 1%. Therefore, the efficiency of the simulated investment portfolio FS can be maintained over a period of time.

As indicated in FIG. 4, if the verifier 122 verifies that the simulated investment portfolio FS meets the verification condition, the simulated investment portfolio FS is outputted (if the verification result of the step S140 of FIG. 2 is “Y’, the method proceeds to step S150); if the verifier 122 verifies that the simulated investment portfolio FS does not meet the verification condition, a null value ø is outputted, and the representative ETF is re-selected (if the verification result of the step S140 of FIG. 2 is “N”, the method returns to step S120).

In the step S150 of FIG. 2, the simulated investment portfolio FS is outputted to the trend forecasting unit 130 by the verifier 122.

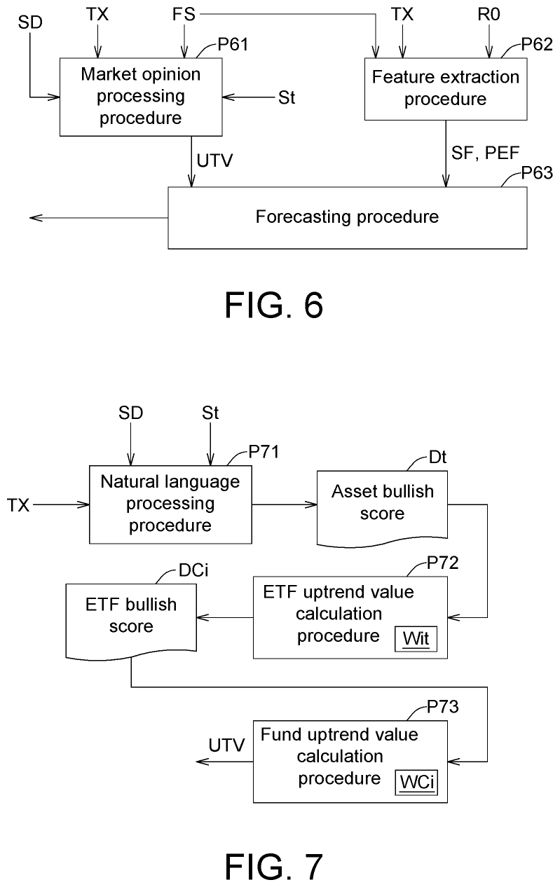

in step S160, the trend of the target fund TF is forecasted by the trend forecasting unit 130 using a deep learning model according to the simulated investment portfolio FS. Referring to FIG. 6, an example of the step S160 performed by the trend forecasting unit 130 is shown. In market opinion processing procedure P61, an uptrend value UTV of the simulated investment portfolio FS is calculated according to a market opinion.

Referring to FIG. 7, an example of market opinion processing procedure P61 is shown. In the natural language processing procedure P71, a market opinion TX is obtained, and the asset bullish score Dt (t=1, 2, . . . ) of each asset St (t=1, 2, . . . ) are calculated according to the financial sentiment dictionary SD, wherein t refers to the t-th asset. For example, a particular market opinion TX is “Macquarie expected gold price is likely to approach USD 2000 per ounce”. According to the analysis of the financial sentiment dictionary SD, “Macquarie” is a legal person, “gold price” is an asset St, “likely” is an opinion of 3 marks, “approach USD 2000 per ounce” is an opinion of 7 marks. Through calculation, the asset bullish score Dt is 5.0 (that is, (3+7)/2). The asset bullish score Dt (t=1, 2, . . . ) of each asset St (t=1, 2, . . . ) can be obtained through the above calculation.

Then, in the ETF uptrend value calculation procedure P72, the ETF bullish scores DCi (i=1, 2, . . . ) of the representative ETFs ECi (i=1, 2, . . . ) can be calculated according to the allocation ratio Wit of each of the representative ETFs ECi (i=1, 2, . . . ) to the asset. The ETF bullish scores DCi can be calculated according to formula (3):

DCᵢ=ΣₜWᵢₜ*D^{t} (3)

Then, in the fund uptrend value calculation procedure P73, an uptrend value UTV of the simulated investment portfolio FS is calculated according to the ETF bullish scores DCi (i=1, 2, . . . ). The uptrend value UTV can be calculated according to formula (4):

UTV=ΣᵢWCᵢ*DCᵢ (4)

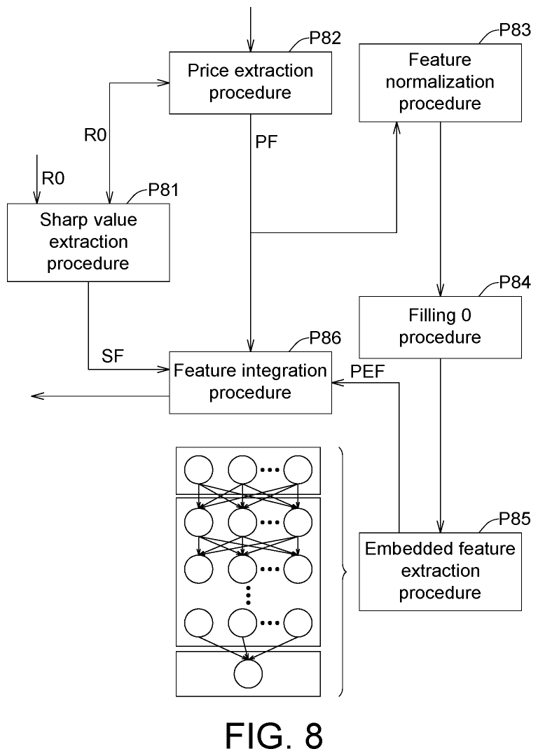

Refer to FIG. 6. The uptrend value UTV is obtained in the market opinion processing procedure P61; the price embedded feature PEF and the Sharp feature SF are obtained in the feature extraction procedure P62. Referring to FIG. 8, an example of a feature extraction procedure P62 is shown. In the Sharp value extraction procedure P81, a Sharp feature SF is extracted according to a risk-free rate RO. In the price extraction procedure P82, a price feature PF over a period of time is extracted. Moreover, through the feature normalization procedure P83, the numeric value of the price feature PF is moved to an interval above 0. Then, through the filling 0 procedure P84, the price feature PF is filled up as a numeric string with a particular predetermined length. Then, the price embedded feature PEF is obtained through the embedded feature extraction procedure P85. Lastly, in the feature integration procedure P86, the Sharp feature SF and the price embedded feature PEF are integrated. In the training model, all funds are trained together. Since the number of representative ETFs ECi varies with the fund, in the training model, some funds have more input of representative ETFs ECi (those funds have more representative ETFs ECi), and some other funds have fewer input of representative ETFs ECi (those funds have fewer representative ETFs ECi). However, deep learning cannot be performed when the number of inputted representative ETFs ECi is inconsistent among the funds. To extract the same number of features, the number of inputted representative ETFs ECi must be consistent. Therefore, in the present embodiment, through the filling 0 procedure P84, for the fund with fewer representative ETFs ECi, each missing feature is replaced with a 0, such that the number of inputted representative ETFs ECi can be consistent.

Refer to FIG. 6. After the uptrend value UTV, the Sharp feature SF and the price embedded feature PEF are obtained, the trend of the target fund can be forecasted using the forecasting procedure P63.

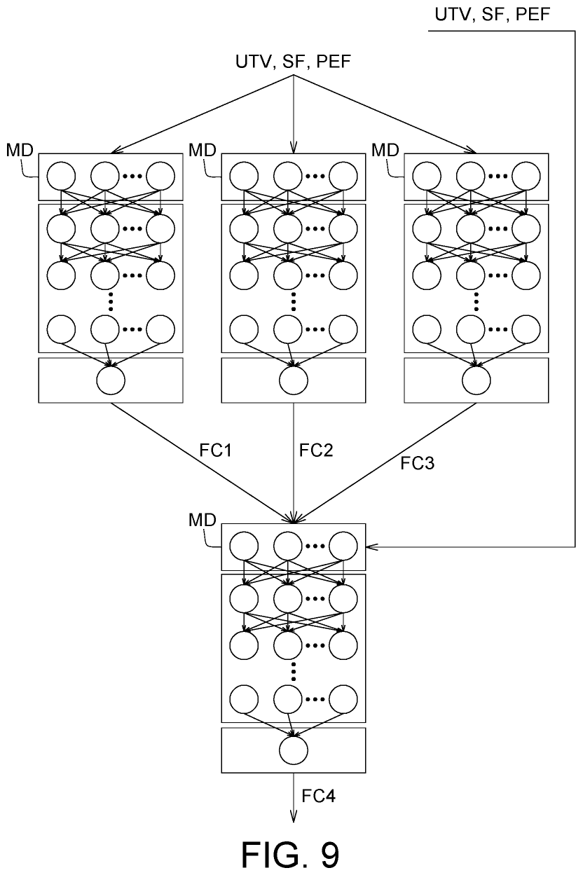

Referring to FIG. 9, an example of a forecasting procedure P63 is shown. In the forecasting procedure P63, the trend of the target fund TF is forecasted using the deep learning model MD. The uptrend value UTV, the Sharp feature SF and the price embedded feature PEF can be inputted to the deep learning model MD to forecast a short-term trend FC1, a mid-term trend FC2 and a long-term trend FC3, respectively. Then, the mid-term trend FC2 and the long-term trend FC3, the uptrend value UTV, the Sharp feature SF and the price embedded feature PEF together are inputted to the deep learning model MD to forecast an overall trend FC4. With the overall trend FC4, the investment advice will be given.

Apart from the above implementation, when the uptrend value UTV is obtained, the investment advice can be directly given according to the uptrend value UTV.

Through the above embodiments, the target fund TF can be accurately tracked, and the trend of the target fund TF can further be forecasted according to the simulated investment portfolio FS.

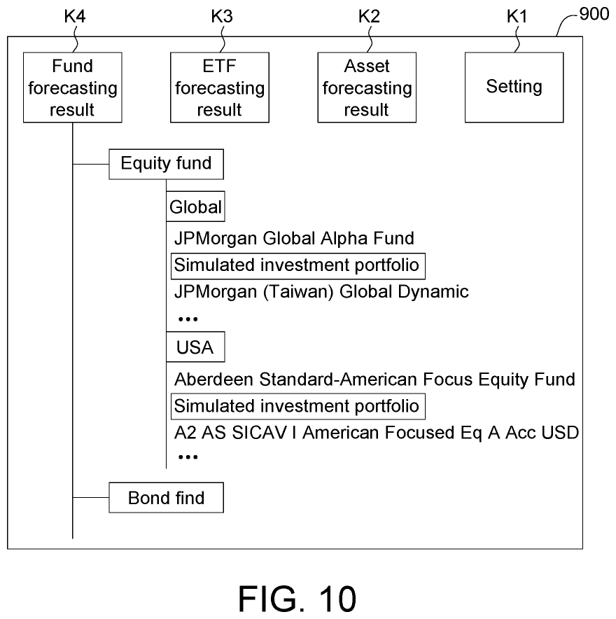

Referring to FIG. 10, a schematic diagram of a graphic user interface 900 according to an embodiment is shown. For the user's convenience, a graphic user interface 900 is provided so that the user can perform the fund tracking method on the smart phone, the notebook computer, or the desktop computer directly. The graphic user interface 900 includes a setting button K1, an asset forecasting result button K2, an ETF forecasting result button K3 and a fund forecasting result button K4. The setting button K1 is used for the user to enter a window to set the target fund TF. The asset forecasting result button K2 is used to display the asset bullish scores Dt (t=1, 2, . . . ) of each asset St (t=1, 2, . . . ). The ETF forecasting result button K3 is used to display the ETF bullish scores DCi (i=1, 2, . . . ) of the representative ETFs ECi (i=1, 2, . . . ). The fund forecasting result button K4 is used to display the uptrend value UTV of the simulated investment portfolio FS or the overall trend FC4.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A fund tracking method used to track a target fund, wherein the fund tracking method comprises:
obtaining a plurality of Exchange Traded Fund (ETF) asset classes according to a fund benchmark index of the target fund;
obtaining a plurality of representative ETFs according to the ETF asset classes;
generating a simulated investment portfolio according to the representative ETFs;
verifying whether the simulated investment portfolio meets a verification condition; and
outputting the simulated investment portfolio if the simulated investment portfolio meets the verification condition.

2. The fund tracking method according to claim 1, wherein in the step of obtaining the ETF asset classes, the ETF asset classes are obtained according to a look-up table.

3. The fund tracking method according to claim 1, wherein in the step of obtaining the representative ETFs, each of the obtained representative ETFs is the best among a plurality of ETFs in each of the ETF asset classes.

4. The fund tracking method according to claim 1, wherein in the step of obtaining the representative ETFs, each of the representative ETFs is obtained at least according to an ETF score.

5. The fund tracking method according to claim 4, wherein in the step of obtaining the representative ETFs, each of the representative ETF is obtained according to a selection count.

6. The fund tracking method according to claim 1, wherein in the step of generating the simulated investment portfolio, a weight of each of the representative ETFs is obtained, sum of the weights is 1, and each of the weights is greater than or equivalent to 0.

7. The fund tracking method according to claim 1, wherein the verification condition is that a similarity in change of Return of Investment (ROI) between the simulated investment portfolio and the target fund is less than a threshold value.

8. The fund tracking method according to claim 1, further comprising:
forecasting a trend of the target fund using a deep learning model according to the simulated investment portfolio.

9. The fund tracking method according to claim 8, wherein in the step of forecasting the trend of the target fund using the deep learning model, the trend of the target fund is forecasted at least according to an uptrend value of a market opinion.

10. The fund tracking method according to claim 8, wherein in the step of forecasting the trend of the target fund using the deep learning model, the trend of the target fund is forecasted at least according to a Sharp value and a price embedded feature.

11. A fund tracking system used to track a target fund, wherein the fund tracking system comprises:
a selection unit, comprising:
an asset class selector used to obtain a plurality of Exchange Traded Fund (ETF) asset classes according to a fund benchmark index of the target fund; and
an ETF selector used to obtain a plurality of representative ETFs according to the ETF asset classes; and
a generation unit, comprising:
an assembler used to generate a simulated investment portfolio according to the representative ETFs; and
a verifier used to verify whether the simulated investment portfolio meets a verification condition and to output the simulated investment portfolio if the simulated investment portfolio meets the verification condition.

12. The fund tracking system according to claim 11, wherein the asset class selector obtains the ETF asset classes according to a look-up table.

13. The fund tracking system according to claim 11, wherein each of the representative ETFs obtained by the ETF selector is the best among a plurality of ETFs in each ETF asset class.

14. The fund tracking system according to claim 11, wherein the ETF selector obtains each of the representative ETFs at least according to an ETF score.

15. The fund tracking system according to claim 14, wherein the ETF selector obtains each of the representative ETFs according to a selection count.

16. The fund tracking system according to claim 11, wherein the assembler obtains a weight for each of the representative ETFs, sum of the weights is 1, and each of the weights is greater than or equivalent to 0.

17. The fund tracking system according to claim 11, wherein the verification condition is that a similarity in the change of Return of Investment (ROI) between the simulated investment portfolio and the target fund is less than a threshold value.

18. The fund tracking system according to claim 11, further comprising:
a trend forecasting unit used to forecast the trend of the target fund using a deep learning model according to the simulated investment portfolio.

19. The fund tracking system according to claim 18, wherein the trend forecasting unit forecasts the trend at least according to an uptrend value of a market opinion.

20. The fund tracking system according to claim 18, wherein the trend forecasting unit forecasts the trend at least according to a Sharp value and a price embedded feature.

21. A graphic user interface used for a user to track a target fund, wherein the graphic user interface comprises:
a setting button used to input the target fund, wherein a plurality of exchange traded fund (ETF) asset classes are obtained according to a fund benchmark index of the target fund, a plurality of representative ETFs are obtained according to the ETF asset classes, and a simulated investment portfolio is generated according to the representative ETFs; and
a fund forecasting result button used to display an uptrend value or an overall trend of the simulated investment portfolio.
